(19) United States
(12) Patent Application Publication
(10) Pub. No.: US 2004/0088201 A1
(43) Pub. Date: May 6, 2004

(54) Method and system for financing future needs

(76) Inventor: Alan J. Lang, Naples, FL (US)

Correspondence Address: SUGHRUE MION, PLLC, 2100 PENNSYLVANIA AVENUE, N.W., SUITE 800, WASHINGTON, DC, 20037, US

(21) Appl. No.: 10/287,050

(22) Filed: Nov. 1, 2002

(51) Int. Cl. G06F 17/60

(52) U.S. Cl. 705/4; 705/35

(57) ABSTRACT

A method and system for financing future intentions of a first party (1, 15) pursuant to a first contract (4, 18) with a Second Party (2, 16) for a specified monetary sum in which a second contract (5, 19) involving a variable annuity is obtained from a Third Party (3, 17).

A guaranteed benefit equal to at least the specified monetary sum is paid to the Second Party by the Third Party to pay for the fulfillment of the future intentions of the First Party.

### BACKGROUND OF THE INVENTION

This invention relates to financial business methods and systems, and more particularly to a method and system for financing future needs or intentions upon the death of a person. Additionally, it relates to a method and system for investing long-term assets of private and public foundations and nonprofit organizations such as 501(c)(3) tax exempt charities.

There are many problems associated with financing for future needs, intentions or requirements, including, without limitation, funeral service, burial services and monies already placed in trust to meet these needs. Heretofore, the conventional method of paying for funeral and burial services has been for a person to enter into a contract which stipulates services including the casket, embalming, transportation, flowers, cemetery, and related items, for an agreed-upon monetary sum. Pursuant to such a contract, a person would normally pay a lump sum at the time of contracting or agree to make timely payments until the price has been paid in full. These payments have heretofore been made directly to the funeral home or cemetery contracting for the services and merchandise selected, in an attempt to avoid the necessity of the deceased's family having to make last-minute decisions at a time when they are most vulnerable and the least able emotionally to make such decisions. Furthermore, it would save money by avoiding the costs of inflation.

Some of the major issues relating to the payment in advance for future services concern portability, cancellations, additional costs not disclosed up-front, refundability, and lack of ability to change or alter the services needed by the client, such as changing the burial plan to a crematory plan. Present practices either result in an outright forfeiture of all the money paid or severe penalties when some or all of the above occur. Moving of elderly parents from one state to another in order for the children to care for them has been a major cause of the “portability” problem. Funeral homes simply do not have the ability to transfer the contracts to other states.

Basically, there have been no federal regulations governing pre-need arrangements. Therefore, every state has established its own unique set of rules and regulations to govern and regulate this industry. Sometimes a funeral home has expended all the monies paid for a particular service, then goes out of business and does not have the money to provide those services upon the death of a person. Often the family has to pay additional monies at the time of the death to provide those services. To combat the problem, most states have required that the funeral home or cemetery selling these services must place in a trust account varying amounts of the monies paid in advance for pre-need policies.

This has led to even more problems with the monies required to be placed in trust accounts and the ability of the funeral home to access those funds. In cases of outright fraud, some funeral homes and cemeteries simply refuse to put the money into trust accounts until they are discovered. Some states require 100% of the monies be placed in trust and others only require as little as 50% be placed in trust. Some states allow annual withdrawals of amounts placed in trust. Furthermore, many funeral homes have requirements concerning trust funds that differ from the cemetery's requirements concerning trust funds, and, furthermore, “services” have requirements for handling trust funds that differ from “merchandise” providers.

Because of the attempts by the states to curb abuses and fraud in the handling of these trust funds, restrictions on how the money may be invested and who must be employed to manage the funds, the actual returns on the money placed in trust is, at best, three percent (3%) annually when the stock market and interest rates are normal. In some cases, even this small amount is consumed by management fees and administrative charges. In recent times, there have been losses in these accounts resulting in funeral homes being required to provide services that cost them more than they received for the original contact.

A similar, but slightly different, need arises in the nonprofit world. Certain charitable gifting programs are designed to provide monies to the charities upon the death of the donor. Good examples of these programs are charitable remainder trusts, charitable gift annuities, charitable lead trusts and pooled income funds. Permanent endowment funds and donor advised funds are meant to provide income but must also preserve the original principal in order to do so. The present invention will guarantee the preservation of the principal and a minimum annual return on same.

Thus, a need exists for a method and system that will eliminate the foregoing problems concerning pre-need financing. The prior art includes the following U.S. Patents involving financial systems, but none like the present invention:

| U.S. Pat. Nos. | INVENTORS | ISSUE DATE |
|---|---|---|
| 6,107,063 | Nilssen | Jul. 23, 1992 |
| 5,742,775 | King | Jan. 18, 1995 |
| 6,343,272 | Payne et al. | Dec. 30, 1999 |
| 6,192,347 | Graff | Aug. 14, 1998 |
| 6,148,292 | King | Oct. 17, 1997 |
| 6,049,772 | Payne et al. | Dec. 19, 1996 |
| 5,966,693 | Burgess | May 7, 1996 |

### SUMMARY OF THE INVENTION

The object of the present invention is to provide the numerous benefits to both the person needing the future services (hereinafter referred to as the “Client”), and the “Second Party” (the entity providing the services), among those benefits being the following:

The Client is not required to pay any amount “up-front” to the Second Party, which eliminates the need for current trust revisions;

The Client has control of the contractual arrangements with the Second Party until the Client's death;

The Client then may move anywhere at any time without having to request or negotiate a refund;

The Client may change the beneficiary (i.e. the funeral home or cemetery) at will;

The Client may change the Second Party providing the services at will;

The contractual arrangement is tax-deferred and the Second Party (as beneficiary) is responsible for any income taxes;

The contractual arrangement is not subject to probate, eliminating any delay in payment to the funeral home or cemetery due to court proceedings;

The Client's money for future services is 100% invested in mutual funds which are held in a separate account by the insurance company, eliminating the possibility of being spent or attached by creditors in the event of bankruptcy;

The Second Party is protected against inflation by the guaranteed annual increase of the death benefit;

The Second Party receives a guaranteed minimum rate of return to help cover the ever-increasing future costs of providing the services;

The Second Party is additionally benefitted by any and all increases in the market value of the mutual fund investments because, at the death of the Client, it will receive the highest of the guaranteed minimum increase or the market value of the investments.

The Second Party is entitled to 100% of the death benefit proceeds in the contract.

The present method and system achieves the above objectives and benefits by providing a method and system to finance future needs involving two contractual arrangements instead of the conventional one contractual arraignment currently in use. The first contractual arrangement is between the Client who needs future services and/or goals and a Second Party that can provide for the future needs and services. The second contractual arrangement is between the Client (or, in some cases, the Second Party) and a Third Party to provide a monetary sum to cover those needs upon the death of a Client.

Under this system, a Client who must provide for future needs enters into a contract with a Second Party capable of providing the future needs desired by the Client for a fixed monetary sum. Then, the Client will enter into a Variable Annuity Contract (VA) with the Third Party. Among other things, the contract provides a death benefit guarantee equal to the monetary sum to meet the cost of needs and services being provided by the Second Party. The Second Party must be named as the Beneficiary of this VA contract. Upon the death of the Client, the Third Party arranges for payment to the Second Party. In most cases, the Second Party would be a funeral home or provider of burial services or an existing pre-need trust account. If the Second Party is a non-profit beneficiary such as a charitable trust or endowment, the Second Party may use money donated by the Client to purchase a variable annuity contract providing similar benefits.

The above and other objects, features and advantages of the present invention should become even more readily apparent to those skilled in the art upon a reading of the following detailed description in conjunction with the drawings, wherein illustrative embodiments of the invention are shown and described.

### BRIEF DESCRIPTION OF THE DRAWINGS

In the following detailed description, reference will be made to the attached drawings in which:

FIG. 1 is a block diagram illustrating the system of the present invention;

FIG. 2 is a block diagram of the present invention as applied to the financing of funeral services;

FIG. 3 is a block diagram illustrating the steps involved in the method of the present invention;

FIG. 4 is a block diagram showing the method and system of the present invention as applied in a charitable scenario, and;

FIG. 5 is a block diagram showing the major steps of the method of the present invention as applied in a charitable scenario.

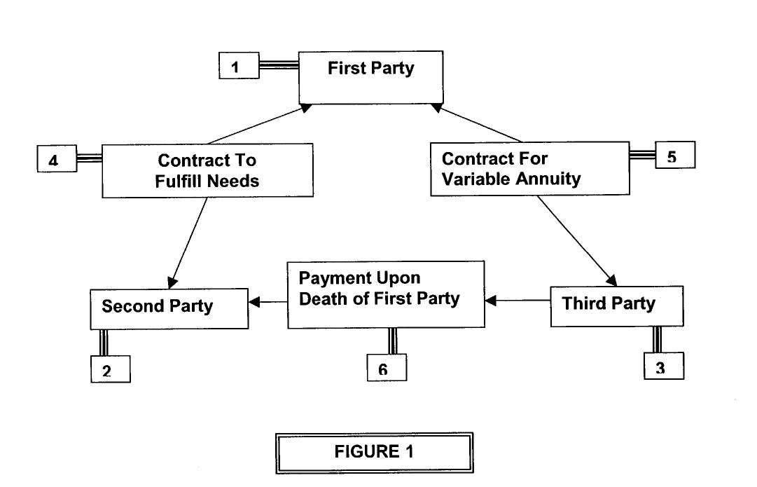

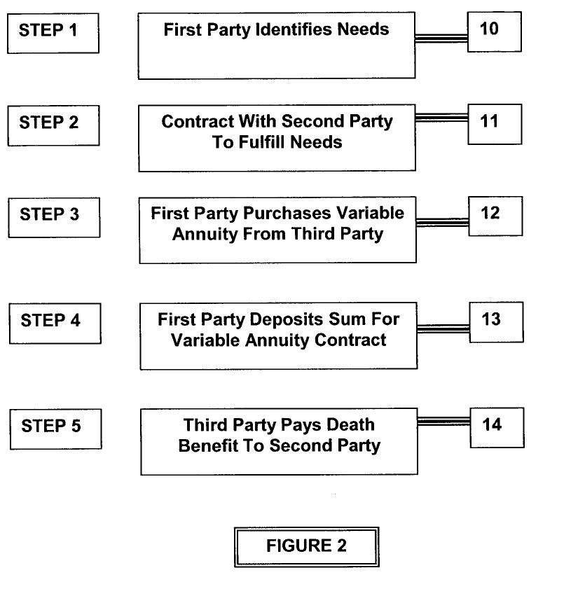

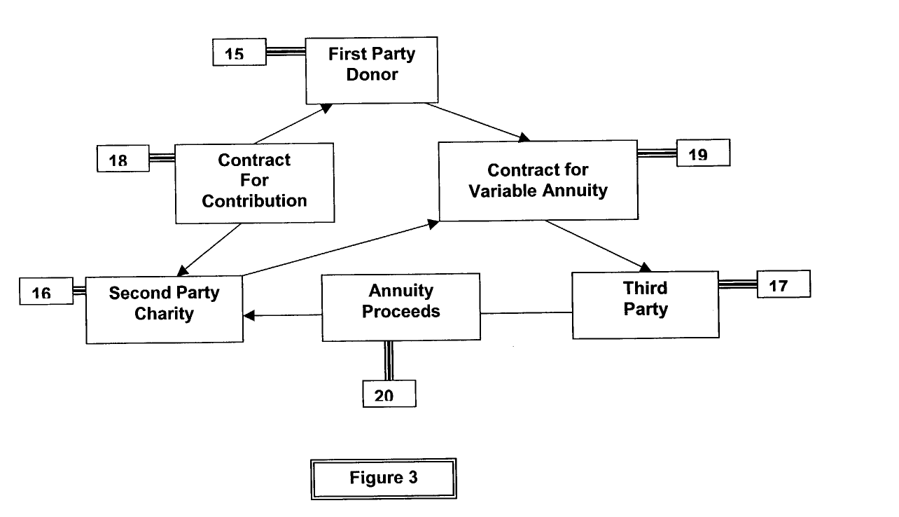

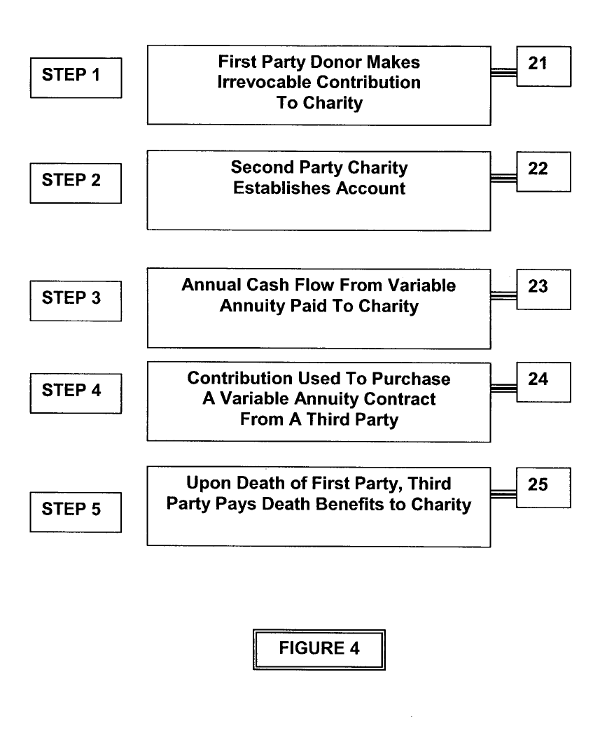

### DESCRIPTION OF THE PREFERRED EMBODIMENTS

For purposes of describing the preferred embodiment, the terminology used in reference to the numbered components in the drawings is as follows:

1. First Party

2. Second Party

3. Third Party

4. Contract to fulfill needs

5. Variable Annuity contract to pay for needs

6. Payment from the Third Party for the Second Party of Variable Annuity for needs

7. Fulfillment of need by Second Party

9. STEP 1: First Party identifies the needs to be fulfilled.

10. STEP 2: First Party and Second Party contract to fulfill needs

11. STEP 3: Variable Annuity contract Third Party provides

12. STEP 4: Deposit on Variable Annuity

13. STEP 5: Payment of Variable Annuity proceeds to Second Party

14. First Party donor

15. Second Party charity

16. Third Party

17. Contract for contribution

18. Variable Annuity Contract

19. Annuity proceeds

20. STEP ONE: First Party donor contracts charitable contribution

21. STEP TWO: Charity establishes account for contribution

22. STEP THREE: Purchase of Variable Annuity Contract

23. STEP FOUR: Annual sum paid to charity

24. STEP FIVE: Payment upon death of First Party donor.

The present invention is best described by reference to the accompanying drawings. In FIG. 1, the system of the present invention is shown to involve three-parties: a First Party 1 having future needs, intentions or requirement to be fulfilled; a Second Party 2 which is capable and willing to provide or fulfill the needs intentions or requirements of the First Party 1 for a specified monetary sum; and a Third Party 3, capable of providing a Variable Annuity Contract to guarantee payment to the Second Party 2 for fulfilling the needs of the First Party 1. This system also involves two contractual arrangements: The first contractual arrangement is between the First Party 1 and the Second Party 2 which specifies the needs the First Party wishes to have fulfilled and at what price the Second Party 2 agrees to fulfill those needs. The second contractual arrangement 5 is between the First Party 1 and the Third Party 3 to provide a variable annuity to pay the specified price to the Second Party 2 to fulfill the needs of the First Party 1. Under the second contract 5, the First Party 1 deposits a lump sum necessary to obtain a variable annuity contract that will yield a payment 6 upon the death of the First Party 1 to the monetary sum due under the first contract 4.

The Variable Annuity Contract (VA) 5 has certain characteristics. It pays a guaranteed death benefit that increases by a minimum set percentage (usually between 5% and 7%) annually and permanently locks in the increase on every anniversary date of the contract, to be paid to the Second Party 2 upon the death of the First Party 1. Additionally, the VA 5 may include an immediate bonus (usually 3% to 5%) that is added to the deposited amount, depending on the age of the Client 1. The Second Party 2 which may be a funeral home, cemetery or trust is then named as the sole beneficiary of the VA 5 and is entitled to receive all of the profits from the VA 5. The First Party 1 remains the owner and annuitant of the VA 5, thus retaining all power and control over changes in the VA's 5 beneficiary during the life of the First Party 1, a distinct advantage over conventional contractual arrangements. Because the death benefit is now guaranteed as a separate part of the new contract, the money may be safely invested in mutual funds for maximum market growth. The Second Party 2 is now assured that it will never receive less than a 5% to 7% growth on the deposited amounts and possibly may receive even more if the underlying mutual funds grow at a higher rate.

The second contract between the First Party 1 and the Second Party 2 may also include provisions which set forth the penalties the First Party may face in the event the VA 5 contact is cancelled or changed in any way, or if the First Party 1 should change the Beneficiary to anyone other than the Second Party 2. The Second Contract will also contain provisions that will relieve the Second Party 2 from any contractual obligations under the contract for services in the event any of these contingencies occur.

Notwithstanding such provisions, however, if the Second Party 2 is a funeral home, cemetery or trust, upon the death of the First Party 1 the Third Party 3 will arrange for all death benefits of the VA 5 to be paid to the Second Party 2. The Second Party 2 will then have the money to provide the goods and services associated with the death of the First Party 1, such as a casket and/or cemetery lot, funeral services, and related items.

Although the present invention has previously been described primarily in relation to a funeral home business, it is intended to apply to any situation in which a first party has needs that must be fulfilled when said party becomes deceased.

The application of the present invention to a charitable situation is illustrated in FIG. 3. A first party donor 15 identifies the need for a charitable contribution which could be to a permanent endowment fund, charitable remainder trust, charitable lead trust, pooled income fund, charitable gift trust or a donor advised trust. All of the aforementioned are characterized as “long term” types of investments and demand protection of principal and a guaranteed income stream. The First Party 15 enters into a contract for a charitable contribution 18 which, in the case of “donor advised funds”, provides that the First Party 15 is to direct the annual gifting. Under conventional practice, a charity would then invest the contribution into a combination of stocks and/or bonds, and accept the usual risks of fluctuating interest rates and the rise and fall of the stock market and bond values.

In the case of the present invention, it is critical to understand the significance of the guaranteed death benefit and its annual increase. In cases where a guaranteed annual cash flow is required (i.e. permanent endowment fund) this annual increase is actually available to be withdrawn every year. The net result is the amount withdrawn is subtracted from the increased death benefit resulting in a return of the death benefit to the original amount deposited. This guarantees the safety of the original principal; provides a minimum annual cash flow; and allows investment in mutual funds to capture any growth above the minimum guaranteed increase in the death benefit.

FIG. 5 illustrates the major steps involved in the system as applied to a charitable scenario. First, in Step One, the first party donor 21 makes an irrevocable contribution to the charity, usually under Section 501(c)(3) of the Internal Revenue Code with contractual specifications or instructions as to the purpose of the donation.

Next, in Step Two, the second party charity 22 establishes an account for the First Party/Donor 21 and provides a tax deductible receipt for the donation.

Next, in Step 3, the contribution 23 is used to purchase a variable annuity contract from a Third Party. The charity is named as the Owner and Beneficiary while the First Party/Donor is usually named as an “annuitant”, depending on the Donor's age at the time of the initial contract. The unique feature of the “annuitant” in all VAs is that it may be anyone, due to the fact that it does not have any ownership rights, interest in, or control over the contract. In the cases of trust-owned annuities (which is the case with all charities or foundations) the “annuitant” is merely lending its life expectancy to the organization because the death benefits will be paid upon the annuitant's death. The reason for this is that a trust cannot die; therefore, there must be a living person upon which to base the death benefits.

Next, in Step 4, after a set period of time, usually one day after the anniversary of the variable annuity contract (and each year thereafter), the annual cash flow 24 under the variable annuity contract is paid to the charity. The variable annuity contract also carries a guaranteed step-up of the death benefit. An annual review is normally performed, involving a comparison of market value of the annuity to the death benefit of the annuity to determine whether any increases in the annual cash payment should be made.

In the final Step 5, 25, upon death of the annuitant, the guaranteed death benefits are paid by the Third Party to the charity. A major advantage of the present system, contrary to conventional arrangements, is that all the money from the First Party Donor is held in an insurance company separate account and is not subject to the creditor's claims, either of the insurance company or the Third Party.

Although only a few embodiments of the present invention have been described in detail herein above, all improvements and modifications to this invention within the scope or equivalents of the claims are included as part of this invention.

Having thus described my invention, I claim:

1. A method for financing future needs of a First Party, said method comprising the steps of:
the First Party entering into an agreement with a Second Party to fulfill the intentions desired by the First Party for a specified monetary sum;
purchasing a variable annuity contract from a Third Party, said contract having a guaranteed death benefit equal to the amount of the monetary sum and a guaranteed annual increase in the death benefit; and
said Third Party paying the guaranteed death benefit to the Second Party upon the death of the First Party to pay for fulfilling the intentions.

2. The method of claim 1 wherein:
the Second Party is a funeral home.

3. The method of claim 1 wherein:
the Second Party is a cemetery.

4. The method of claim 3 wherein:
the Second Party is a non-profit beneficiary.

5. The method of claim 3 wherein:
the Second Party is a funeral trust.

6. The method of claim 3 wherein;
the Second Party is a charitable entity.

7. The method of claim 3 wherein;
the Second Party is a charitable trust.

8. The method of claim 3 wherein;
the Second Party is a pooled income fund

9. The system of claim 3 wherein:
the Second Party is a charitable gift annuity.

10. The method of claim 3 wherein;
the Second Party is a charitable lead trust.

11. The method of claim 3 wherein;
the Second Party is a permanent endowment fund.

12. The system of claim 3 further comprising:
said Third Party paying a pre-determined annual sum to the Second Party during the life of the First Party.

13. A system for financing the future needs of First Party, said system comprising;
a first contract between the First Party and Second Party to fulfill the needs of the First Party for a specified monetary sum; and
a second contract between at least one of the First Party and a Third Party to pay to said Second Party an amount equal to no less than the specified momentary sum upon the death of the First Party, said second contract involving a variable annuity.

14. The system of claim 7 wherein;
the Second Party is a funeral home or cemetery or funeral trust.

15. The system of claim 7 wherein;
the Second Party is a nonprofit beneficiary.

16. The system of claim 7 wherein;
the non-profit beneficiary is a charitable trust.

17. The system of claim 7 wherein;
the second contract includes the payment of a pre-determined annual sum to the Second party during the life of the First Party.
